(19) United States
(12) Patent Application Publication
(10) Pub. No.: US 2006/0082159 A1
(43) Pub. Date: Apr. 20, 2006

(54) Rentricity Flow-to-Wire and RenFlow information services

(76) Inventors: Jason Sylvain Scharfspitz, New York, NY (US); Frank Vincent Zammataro, Chatham, NJ (US)

Correspondence Address: Frank Zammataro, 7-Kincaid Lane, Chatham, NJ, 07928, US

(21) Appl. No.: 10/966,996

(22) Filed: Oct. 18, 2004

(51) Int. Cl. H02K 7/18; F03G 7/08; F02B 63/04

(52) U.S. Cl. 290/1 R

(57) ABSTRACT

The invention is focused on transforming untapped energy in man-made processes into electricity. The surplus power being targeted is contained within pipes where gases, liquids, or solids exert extra pressure. This can be a byproduct of a chemical reaction, occur during release of compressed gas, or result from gravity pulling material from an elevated physical position to a lower one. To harness this energy the invention consists of a micro-turbine, generator, sensors, processors, electronic controls, and communications equipment that operate autonomously. The electricity produced by the devices will be consumed by a generating entity, delivered to other end-users, or sold into the power grid. The invention will use information services, comprised of computer software, to acquire, store, and report performance and security information transmitted from remote locations to persons who work for the generating entity and/or other third parties.

### FIELD OF INVENTION

This invention relates to processes for the recovery of energy from man-made systems by extracting lost energy from pressurized flows. More particularly, this invention provides energy recovery while monitoring the related infrastructure.

### BACKGROUND

Renewable energy sources are in demand to offset reliance on traditional forms of power generation.

Surplus power is contained within pipes where gases, liquids, or solids exert extra pressure. This can be a byproduct of a chemical reaction, occur during release of compressed gas, or result from gravity pulling material from an elevated physical position to a lower one.

Presently, pressure reduction valves lower pressure to optimal levels without performing useful work with the energy they remove from a system. For example, in municipal water distribution—specifically where water is stored at high elevation relative to the population it serves. Tall water columns create excessive pressure at their base, which is reduced prior to the water being delivered to the end-customer. Pressure reduction valves have been used for decades to lower the pressure of piped materials to optimal levels—and have not performed useful work with the energy they remove from the system.

Following the terrorists attacks of 2001, critical infrastructures (such as water distribution systems) require increased security to avoid disruption.

### SUMMARY OF INVENTION

The invention will integrate advanced technologies across a number of distinct areas to configure its energy recovery system. Turbine, generator, electronic control, sensor, communications, and microprocessor capabilities will be combined within a single device to mimic the flow and pressure regulating capabilities of valves and simultaneously convert surplus mechanical energy into high quality electricity.

The invention consists of a number of existing mechanical and electric components that have been uniquely combined to address and capture surplus power contained specifically in pipes. The invention performs the dual role of power generation and material flow conditioning, which ordinarily would be performed by a stand-alone or series of pressure reduction valves.

The invention's components—which include a configuration of micro-turbine, flywheel, generator, sensors, processors, electronic controls, and communications equipment—operate autonomously.

The invention applies a micro-turbine at variable speed to recover maximum energy surplus.

The invention applies a valve that closes in a graduated fashion as an outlet valve.

The invention applies a valve that closes in a graduated fashion as an inlet valve.

The invention applies a spinning flywheel that maintains inertia which retards rapid changes in flow and pressure.

The invention includes information services that will monitor and deliver valuable operating information. The information services will be facilitated by software and hardware that stores data and makes it available in a variety of useful formats over wired and wireless networks. The information services will be accessed via the Internet and rely primarily on server-side software that contains application logic. The invention provides a method of systematically accumulating data from remote power generation sites, performing analytics on the information, and making it available in a variety of formats to maximize power production and efficiency and to enable overall piping optimization.

The invention will not produce any air pollution or waste ash—byproducts of fossil fuel electricity generation plants—nor further the environmental impact that occurs during the extraction of coal, natural gas, and oil. The invention, similar to other existing renewable technologies, will help to lessen dependence on oil and coal for energy.

The invention provides a method for applying energy recovery system revenue to the costs of monitoring and securing infrastructure with minimal impact on rates to customers.

### BRIEF DESCRIPTION OF DRAWINGS

FIG. 1 illustrates the primary components of the invention. The invention's micro-turbines will operate autonomously and consist of a number of components that together comprise a complete energy recovery system.

FIG. 2 illustrates the information systems where information from the energy recovery process is monitored and delivered.

### DETAILED DESCRIPTION OF INVENTION

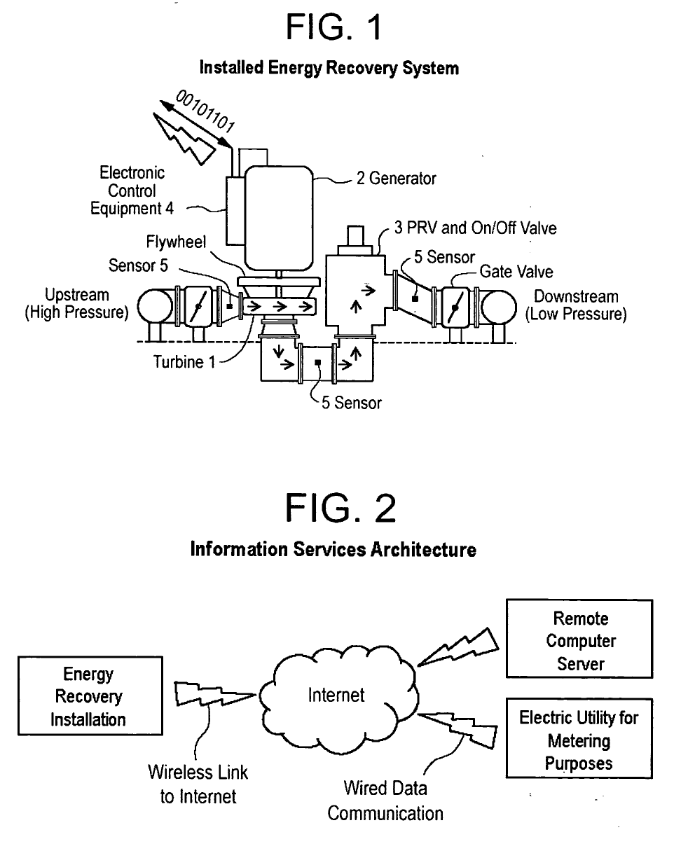

Energy Recovery System Method—The invention's micro-turbine will operate autonomously and consist of a number of components that together comprise a complete energy recovery system. The primary components are listed below and are illustrated in FIG. 1.

Turbine (1) Flowing material will spin the turbine and coupled generator. The turbine will remove the surplus energy from the material by offering a level of resistance, similar to the resistance provided by a valve. The invention usually will use Francis or reverse-pump designs during early installations. During later installations, the invention will include use self-configuring turbines in its systems. The self-configuring models automatically will modify their shape to maintain optimal efficiency across a range of flow and pressure conditions. A connected flywheel will develop momentum and inertia to resist rapid fluctuations in the flow of material through the energy recovery system and to closely maintain consistent frequency of electricity output. The flywheel will ensure that only gradual changes occur in downstream flow conditions to minimize stress on the pipe infrastructure that can result from abrupt differences in flow volume or pressure.

Generator (2) The generator is coupled to the turbine and rotates when material spins it. The energy recovery system usually will use an AC induction generator, which requires an external power source to produce electricity. The external power source can be provided from the power grid, a battery or separate generator system. DC induction will be used in isolated locations where an external power source is not readily available.

Combined Pressure Reduction and On/Off Valve (3) A pressure reduction valve (“PRV”) is positioned downstream of the turbine to remove any excess energy from the system and ensure that flowing material is at the required pressure. The PRV also will have a solenoid mechanism that de-energizes in the event of power grid disruption and completely closes the valve in a slow, calibrated process to prevent destructive “hammer” from occurring in the pipes. The solenoid will re-energize when the power grid becomes operational and will open the valve, which again will function as a PRV.

Electronic Control Equipment (4) Electronic control equipment will synchronize the power produced by the generator with the grid. The electronic control equipment automatically will shut down the micro-turbine during blackouts or grid disruptions, when a reliable external power source is unavailable or in the highly unlikely event of a turbine-generator malfunction. The electronic control equipment will signal the on/off valve to close and restrict material flow. The electronic control equipment also will have the ability to restart the micro-turbine when the grid returns to normal operating conditions. In addition to synchronizing the electricity and performing start-up and shut-down activities, the control equipment also will ensure the safe electrical operation of the device. It will disconnect from the grid if a problem occurs either in the grid or in the micro-turbine itself.

Sensors (5) The energy recovery systems will contain sensors that measure pressure and flow conditions and other parameters dictated by the host site partner. The sensor information will be transmitted offsite, stored in information servers, and be made available to the generating entity. Integral microprocessors will interpret the information and adjust micro-turbine configuration to site conditions.

Communications Equipment—Transmitters will send sensor and electricity metering information in real-time to computer servers. The communications equipment will utilize wired or wireless technology, depending on network availability at the installation site. The devices also will send alert messages, if a problem is experienced, which enables a person to analyze and issue commands to the energy recovery systems remotely. One of the information services is off-site security monitoring of PRV sites. The communications equipment can notify monitors, if individuals gain unauthorized access to distribution infrastructure. This capability is especially relevant when the energy recovery system is installed within public water mains to guard against homeland security threats to the drinking water supply.

Each energy recovery system is configured virtually identically, except for sizing differences to address site-specific characteristics.

Energy Recovery Information Systems—The information services architecture will consist of Web and application software being run on computer servers. Database programs will store the system performance information and make it available through a Web interface. In addition, proprietary coding will enable users to easily access and analyze the data and display it in the most useful report format. The information services software will have table and graphing functions and provide the ability to download data into other applications, such as Microsoft Excel. The application logic will reside on computer servers. However, for wireless users, client-side information services software will reside on the wireless device to speed application functionality, allow for disconnected use, and provide alert messages when certain flow, pressure, and other parameters are exceeded.

The invention's information services consist of four major layers of integrated software. The first layer includes an information capture and databases ability to acquire data transmitted by the remote energy recovery systems. Analytical tools and security monitoring capabilities are part of the second layer. The third layer includes linear programming and optimization functionality that enables turbine-generator component selection that will maximize revenue. Finally, the fourth layer includes communication architecture for wired and wireless capabilities. The primary components are listed below and are illustrated in FIG. 2.

Databases and Accounting Systems Layer—The information system will capture data transmitted from remote energy recovery locations and data available from other sources via the Internet. The information will be stored in a database and be made available to a variety of users in various report formats. Layer 1 includes an accounting system that multiplies net electricity produced—power output from the energy recovery system less power consumed at the installation site—by electricity prices and generates an invoice. Also, this layer will monitor the energy recovery system and provide alert tables and event polling to detect malfunction.

Data Acquisition from Energy Recovery System—Each energy recovery system installation will be given a unique name and identification code. Data transmitted by an energy recovery system will include the following:

Piped material characteristics include pressure (multiple sensors), flow (multiple sensors) and contamination detection.

Electricity generation data including kilowatts, voltage, and frequency

Electricity metering data including the amount of electricity generated by the energy recovery system and the amount of electricity consumed within the installation vault by the energy recovery system, lights, sump pump, ventilation fan, heater, sensors, and other operational equipment.

Energy recovery system performance factors include on/off mode, revolutions per minute (RPM), operating temperature, vibration, and time in use.

Internal vault conditions include temperature and humidity.

In addition to capturing information from sensors integral to energy recovery system installations, the information system will accept data transmissions from sensors located at facilities where an energy recovery system is not present. Data from pre-existing sensors will be incorporated into the information system.

Data Acquisition From Third-Party Information Providers—Data points provided by third-parties and received through an Internet connection include outside air temperature (for municipality where the energy recovery system is installed—from weather service), weather characteristics (sunny, partly sunny, partly cloudy, cloudy, rain, etc.—from weather service), wholesale electricity price (from regional independent electricity system operator), and the operating reserve rate, which is a penalty charged by the regional independent electricity system operator for not participating in the day-ahead market. The operating reserve penalty is subtracted from the real-time electricity price to calculate the price per kilowatt-hour of the electric power being generated at a site.

Accounting System—The information system multiplies the net electricity produced by an energy recovery system installation by electricity prices obtained from a third-party (less operating reserve penalty, if applicable). The system will generate an invoice that can be printed, transmitted to the electricity purchaser as an e-mail message, or made available via a Web site. The system will maintain a record of invoices, collections, and outstanding balances. This data can be aggregated across multiple energy recovery installations for a customer that is purchasing power from more than a single unit.

Alert System—The information system will monitor energy recovery system installations and generate an alert message if a variable exceeds pre-set parameters. The alert message will be electronically sent to the appropriate person's computer. The message will contain a description of the problem, the appropriate host site partner contact, and the name of the emergency response contractor. The alert also will be recorded.

Analytical Tools and Security Monitoring Layer—Layer 2 includes a “control room” software capability for host site partners by linking together the information obtained from two or more locations where sensors measure real-time pipe conditions. Vault security monitoring capabilities are found in this layer in addition to energy recovery system maintenance logs and reporting capabilities.

Control Room—Host site partners will gain the ability to compare sensor information from multiple sites and add and subtract data between or among energy recovery system facilities. A primary purpose of the control room system is to enable partners to determine leakage of piped material. The information system will illustrate which sections of pipe have the greatest leakage and where infrastructure improvement dollars would be most effectively allocated to reduce waste and cost.

Security Monitoring—The information system will send an alert message to person(s) at various business locations including the generating entity, when the entrance to an energy recovery system installation is opened without authorization. Maintenance personnel who intend to access the facility will have the capability to de-activate and re-activate the security system to perform necessary operations. The information system will establish a record of when a station has been accessed, as well as the name of the individual who de-activated the monitoring capability. A protocol for de-activating and re-activating the vault or containment structure will be established and will be based on manual or automatic features. Manual features will require an individual to turn the system on or off in real-time. The automatic capability can be set to turn the alerting system on or off at specific times or on certain days. The system still will log the opening of the structure even when maintenance personnel notify the system of the activity; however, an alert message will not be generated and sent.

Maintenance Log—The purpose of the maintenance log is to ensure that the energy recovery system is serviced at appropriate intervals and that the necessary activities are performed. Maintenance personnel will access the log after performing work on the energy recovery system to confirm that work has taken place. Specific activities will be checked off, and there will be room to add comments and the capability to adjust service intervals. The maintenance log also will send an alert to a person's computer when a necessary service activity is coming due.

Report Formats—The information system will make data available in a variety of useful formats. The information will be plotted against time intervals and/or against other data variables. Report formats will be shown as graphs and tables on Web pages. However, the capability also will exist to download data to an external application, such as Microsoft Excel, where it can be manipulated or presented in an exact format determined by the user. Any data that will be stored or calculated, including accounting information, can be accessed by the report system. The information system will incorporate the ability to easily determine aggregates and averages of various data blocks.

Statistics and Linear Programming Layer—Layer 3 includes the capability to optimize the size of the turbine-generator that is part of the energy recovery system based on pressure and flow conditions and electricity prices at a proposed installation site. The activity will entail loading the turbine performance curves for entire turbine product lines as digital data. The turbine curves indicate operational efficiency for various pressure and flow combinations. The curves also illustrate the volume of flow required at given pressures or vice versa for a turbine with specific dimensions to remain optimized. The information system will import electricity pricing information for a specific site to evaluate the data according to time of day, season, and other factors. The prices will be obtained from a third-party via the Internet. Finally, pressure and flow characteristics for the site will be accessed. The system will perform an optimization calculation by comparing electricity prices, pressure and flow conditions, and turbine efficiency to select the turbine-generator combination that will maximize revenue at the particular site. Where pressure and flow data is not available for at least a year, the system will interpolate data from shorter time periods based on comparable sites.

Communications Layer—The information system will use a wireless communication framework as a bridge between the energy recovery system and the central servers, which enables bidirectional control and monitoring. Through the use of state-of-the-art communication technology, the layer provides near real-time management of the energy recovery system.

1. A method of recovering energy from existing pressurized pipelines, comprising:
applying a configuration of micro-turbine, flywheel, generator, sensors, processors, electronic controls, and communications equipment that operate autonomously.

2. A method of recovering energy from existing pressurized pipelines, comprising:
applying a micro-turbine at variable speed to recover maximum energy surplus.

3. A method of recovering energy from existing pressurized pipelines, comprising:
applying a valve that closes in a graduated fashion as an outlet valve;
applying a valve that closes in a graduated fashion as an inlet valve; and
applying a spinning flywheel that maintains inertia, which retards rapid changes in flow and pressure.

4. A method of systematically accumulating data from remote power generation sites, performing analytics on the information, and making it available in a variety of formats to maximize power production and efficiency and to enable overall piping optimization.

5. A method for applying new technology revenue to the costs of securing infrastructure without impact on rates to utility customers.
